(19) United States
(12) Patent Application Publication
(10) Pub. No.: US 2026/0290003 A1
(43) Pub. Date: Sep. 24, 2026

(54) DETECTION APPARATUS, IMAGE ENHANCEMENT PARAMETER DETERMINATION METHOD AND NON-TRANSITORY RECORDING MEDIUM

(71) Applicants: Shunsuke KUDO, Kanagawa (JP); Yuichi EGUCHI, Tokyo (JP)

(72) Inventors: Shunsuke KUDO, Kanagawa (JP); Yuichi EGUCHI, Tokyo (JP)

(21) Appl. No.: 19/545,058

(22) Filed: Feb. 20, 2026

(30) Foreign Application Priority Data
Mar. 19, 2025 (JP) 2025-045664

(51) Int. Cl. G06V 10/98; G06V 10/30; G06V 10/764; G06V 10/774; G06V 10/82; G06V 10/94; G06V 20/69

(52) U.S. Cl. CPC G06V 10/993; G06V 10/774; G06V 10/30; G06V 10/764; G06V 10/82; G06V 10/95; G06V 20/695; G06V 20/698; G06V 2201/07

(57) ABSTRACT

Acquisition circuitry acquires at least one captured image obtained by capturing a subject including an object having a detection target. Enhancement circuitry generates an enhanced image obtained by image enhancement of the at least one captured image using an image enhancement parameter. Detection circuitry detects an image of the detection target from the enhanced image. Assessment circuitry calculates an assessment value for detection accuracy based on a detection result by the detection circuitry. Control circuitry determines, among a plurality of image enhancement parameters, an image enhancement parameter to be used by the enhancement circuitry for image enhancement of at least one captured image to be analyzed, based on the assessment value calculated for each of a plurality of different image enhancement parameters.

### CROSS-REFERENCE TO RELATED APPLICATIONS

The present application claims priority under 35 U.S.C. § 119 to Japanese Patent Application No. 2025-045664, filed Mar. 19, 2025. The contents of which are incorporated herein by reference in their entirety.

### BACKGROUND OF THE INVENTION

### Field of the Invention

The present disclosure relates to a detection apparatus, an image enhancement parameter determination method and a non-transitory recording medium.

### Description of the Related Art

There are technologies for detecting images of minuscule detection targets in images (captured images) captured at prescribed magnifications. Additionally, image processing algorithms such as those for particle analysis are known.

However, with the image processing algorithms used for particle analysis, etc., it is difficult to distinguish, for example, between particulate minuscule detection targets and noise in the captured images. For this reason, minuscule detection targets and large quantities of noise can both be extracted from captured images, thereby lowering the accuracy of particle analysis. Additionally, depending on the fluorescent dye, the experimental conditions, or the detection target, the image quality of the captured images can become lower, thereby making it difficult to distinguish between the detection targets and noise in the captured images.

For example, in applications for detecting minuscule cell structures or tissue structures from fluorescent stain images of cells and tissues, there are cases in which the image quality (image characteristics such as brightness and contrast) of the fluorescent stain images obtained by image capture are different, even for cells or tissues cultured under the same conditions, depending on the maturity level of the cells or tissues, the staining method or the degree of staining, the structures or materials of plates, and the characteristics of optical systems such as microscopes. Under the influence of such variations in image quality, there is a risk that analysis results will differ with the same image processing algorithm, even between trials for which equivalent results are expected.

### SUMMARY OF THE INVENTION

An example of an aspect of the present disclosure is a detection apparatus provided with acquisition circuitry configured to acquire at least one captured image obtained by capturing a subject including an object having a detection target, enhancement circuitry configured to generate an enhanced image obtained by image enhancement of the at least one captured image using an image enhancement parameter, detection circuitry configured to detect an image of the detection target from the enhanced image, assessment circuitry configured to calculate an assessment value for detection accuracy based on a detection result by the detection circuitry, and control circuitry configured to determine, among a plurality of image enhancement parameters, an image enhancement parameter to be used by the enhancement circuitry for image enhancement of at least one captured image to be analyzed, based on the assessment value calculated for each of a plurality of different image enhancement parameters.

### BRIEF DESCRIPTION OF THE DRAWINGS

FIG. 1 is a diagram illustrating an example of a configuration of a detection system in a first embodiment; FIG. 2 is a diagram illustrating an example of a plate in the first embodiment; FIG. 3 is a diagram illustrating an example of preprocessing with respect to an enhanced image in the first embodiment; FIG. 4 is a diagram illustrating an example of preprocessing and a detection process with respect to an enhanced image in the first embodiment; FIG. 5 is a flow chart indicating an example of operations in a detection process in a detection system in the first embodiment; FIG. 6 is a flow chart indicating an example of operations in an image enhancement parameter determination process in a detection system in the first embodiment; FIG. 7 is a flow chart indicating an example of operations in an image enhancement parameter determination process in a detection system in Modified Example 1 of the first embodiment; FIG. 8 is a flow chart indicating an example of operations in an image enhancement parameter determination process in a detection system in Modified Example 2 of the first embodiment; FIG. 9 is a diagram illustrating an example of a configuration of a detection system in a fourth embodiment; FIG. 10 is a diagram illustrating an example of a captured image used for training in the fourth embodiment; FIG. 11 is a flow chart illustrating an example of operations in a training apparatus in the fourth embodiment; FIG. 12 is a diagram indicating detection amounts in respective enhanced images using the same image enhancement parameters; FIG. 13A is a first diagram illustrating assessment values for each image enhancement parameter; FIG. 13B is a second diagram illustrating assessment values for each image enhancement parameter; FIG. 13C is a third diagram illustrating assessment values for each image enhancement parameter; and FIG. 14 is a diagram illustrating detection amounts in respective enhanced images using image enhancement parameters in which the assessment values are minimized.

### DESCRIPTION OF THE EMBODIMENTS

An example of an objective of the present disclosure is to provide a detection apparatus, an image enhancement parameter determination method, and a non-transitory recording medium for recording a program that can stabilize the detection performance of images of minuscule detection targets, even in captured images of different image quality.

The embodiments of the present disclosure determine image enhancement parameters, which are parameters used for image enhancement performed on captured images so that detection can be stably performed when using an image processing algorithm to detect images of minuscule detection targets from the captured images. Hereinafter, embodiments of the present disclosure will be described in detail with reference to the drawings.

### First Embodiment

The first embodiment is a basic embodiment of the present disclosure. The detection apparatus of the first embodiment performs a process (hereinafter referred to as a detection process) for detecting images of minuscule detection targets from captured images. As a specific example, use for quantifying the number of synapses from a fluorescent microscope image captured of a neuron can be contemplated. The detection apparatus performs image enhancement on the captured images before the detection process. As a result thereof, variation in detection results caused by variation in image quality is suppressed and the detection results are stabilized. However, in fluorescence imaging of cells, the brightness of captured images can largely change depending on the image capture device or on the state of the cells. For this reason, the appropriate image enhancement parameters will differ in accordance with the image quality. Therefore, the detection apparatus of the present embodiment determines image enhancement parameters for image enhancement performed before the detection process.

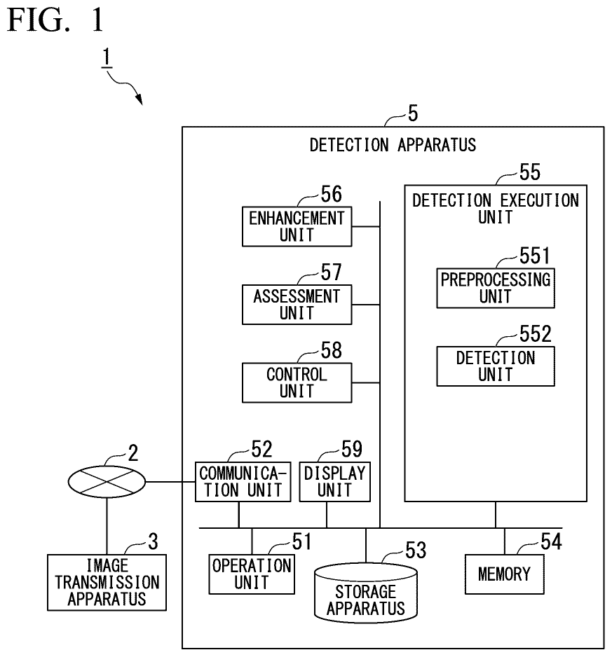

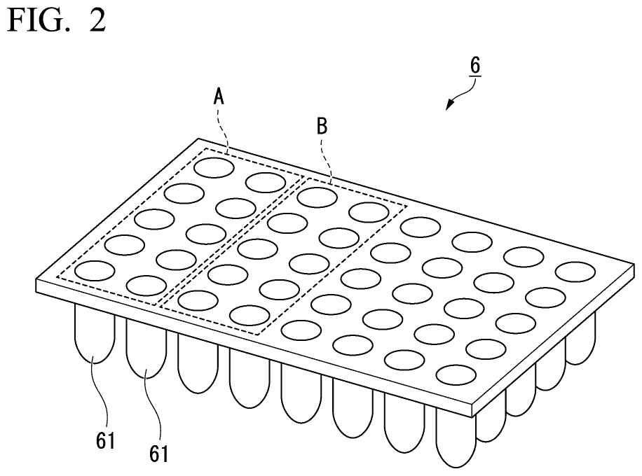

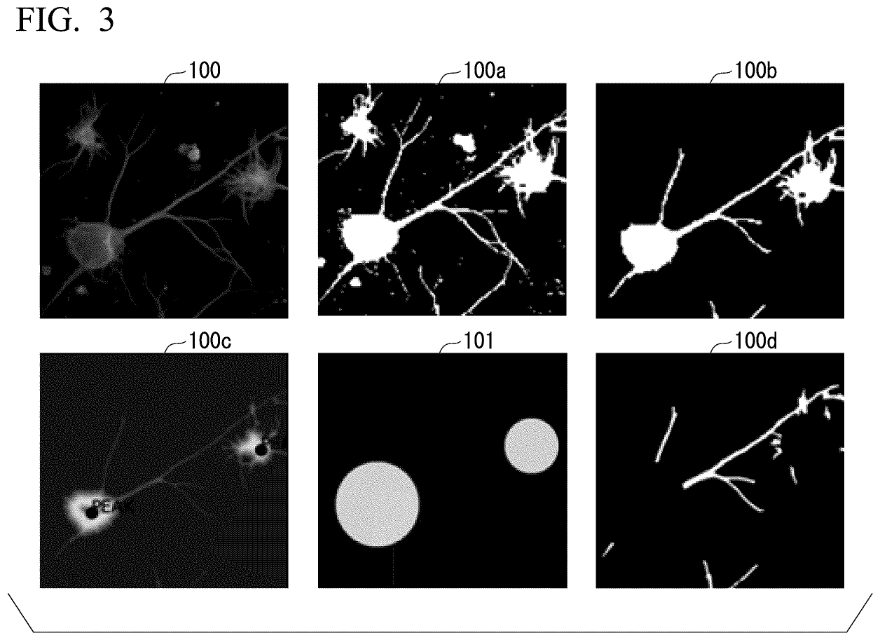

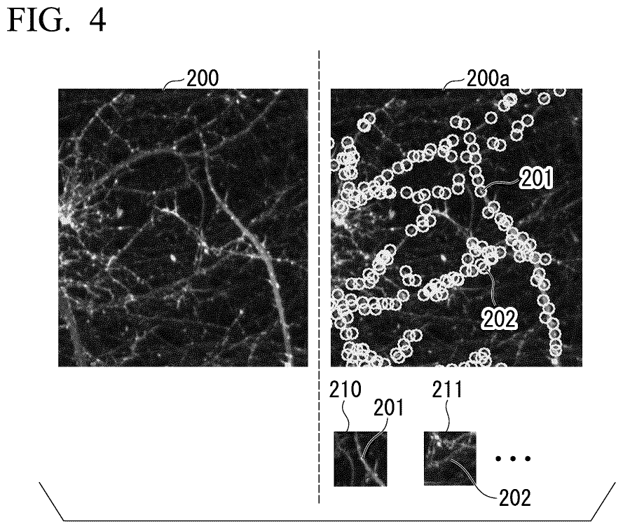

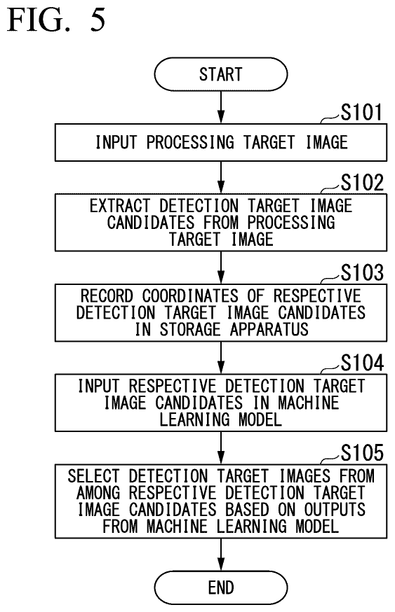

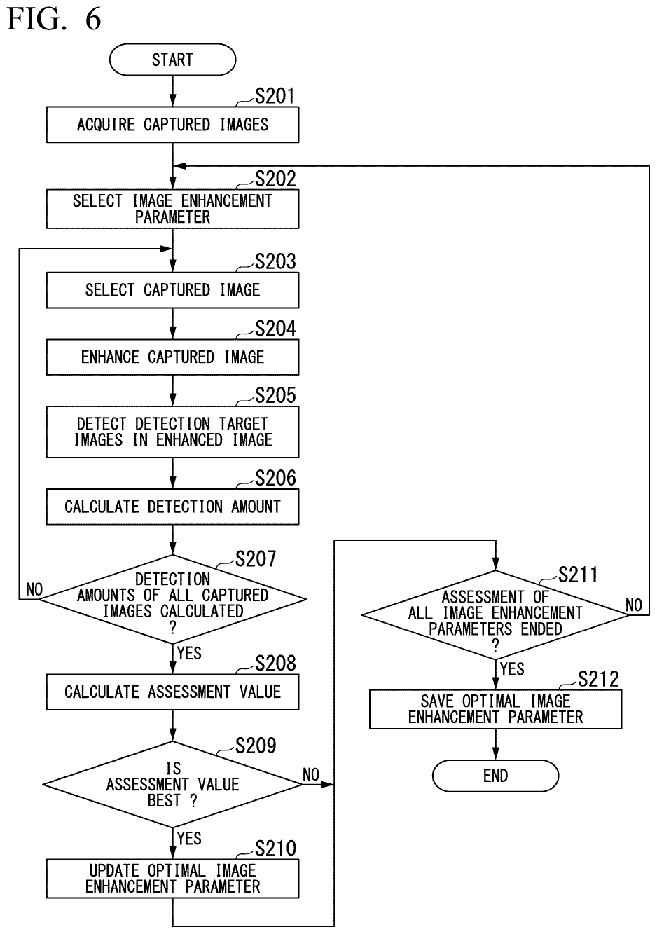

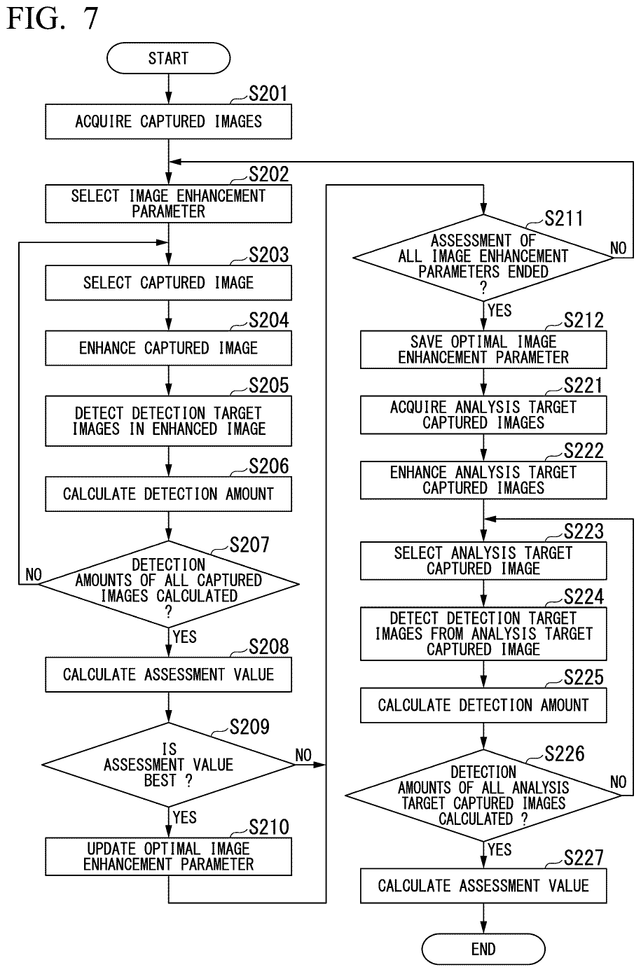

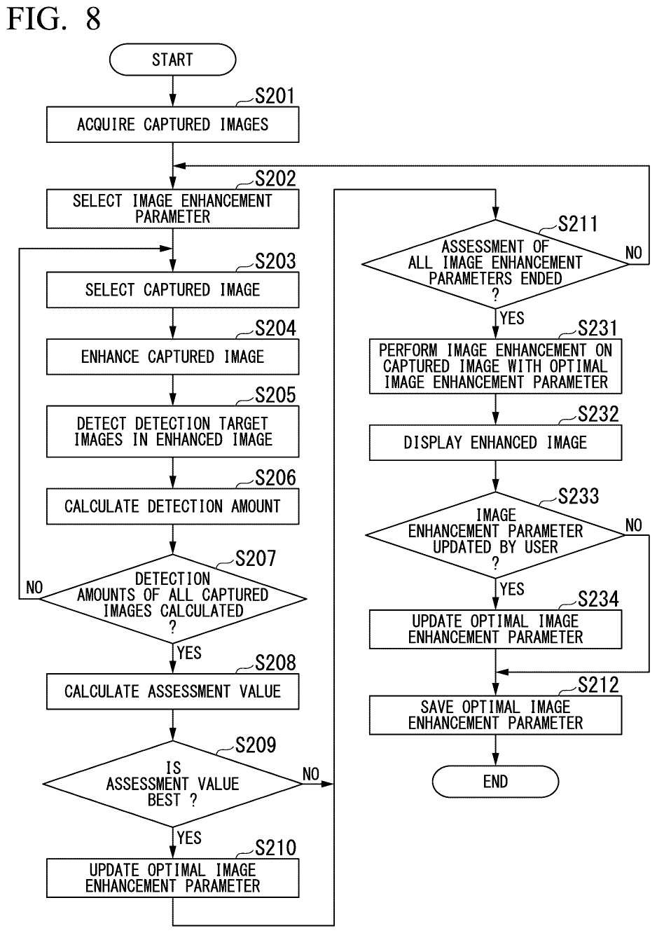

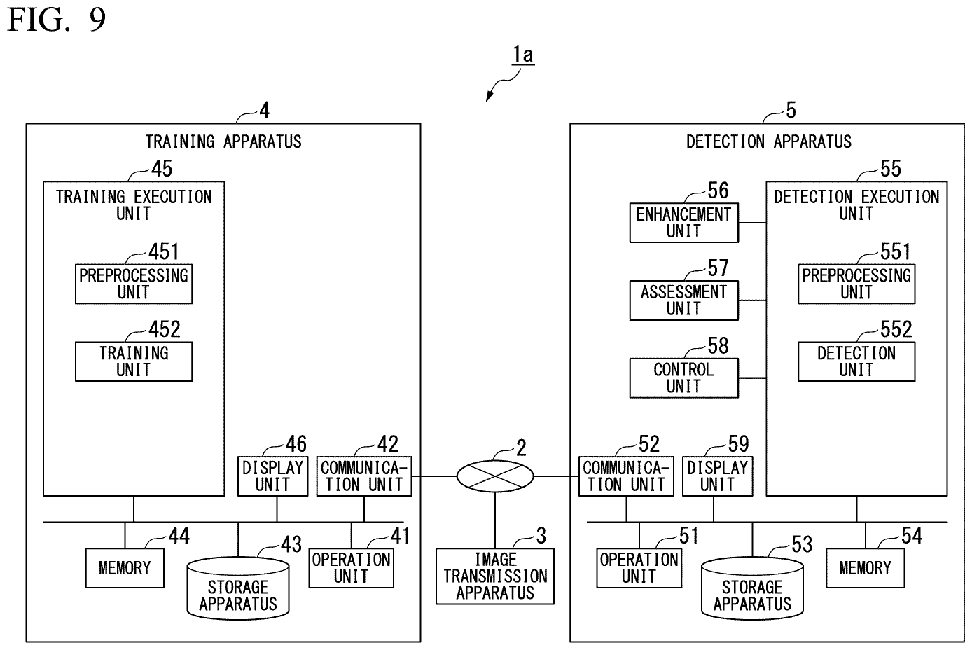

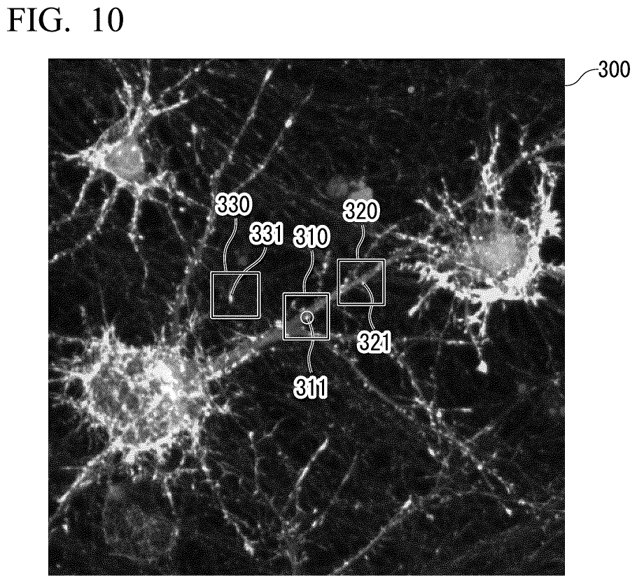

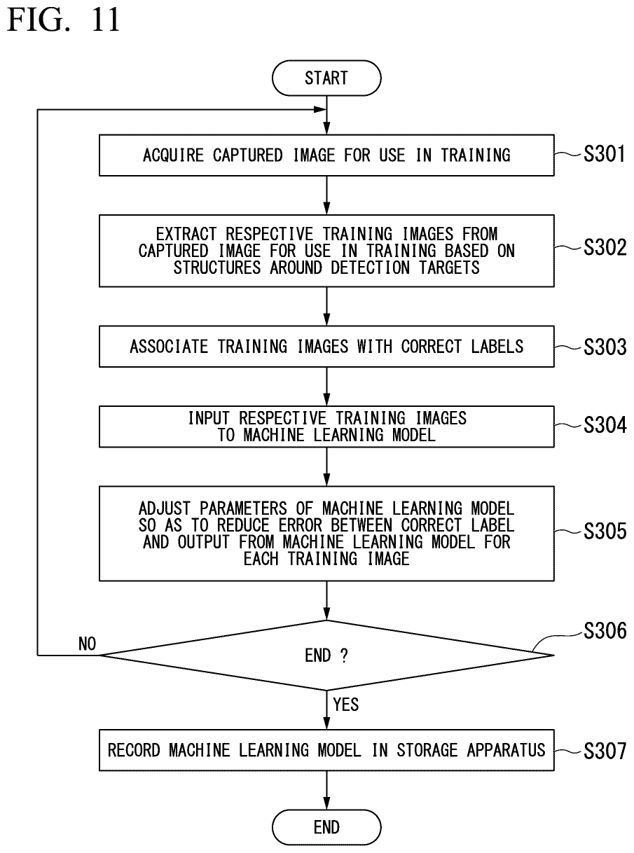

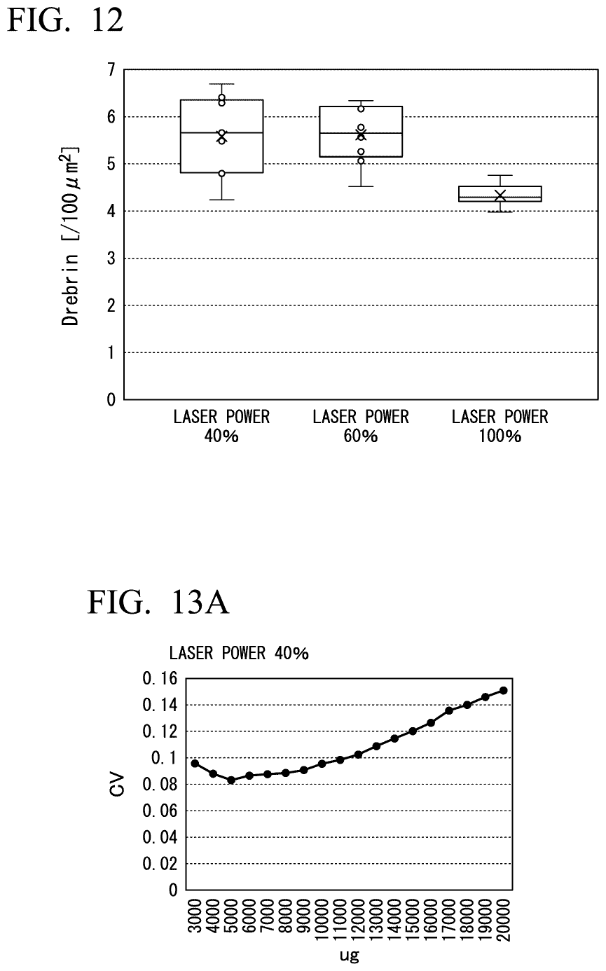

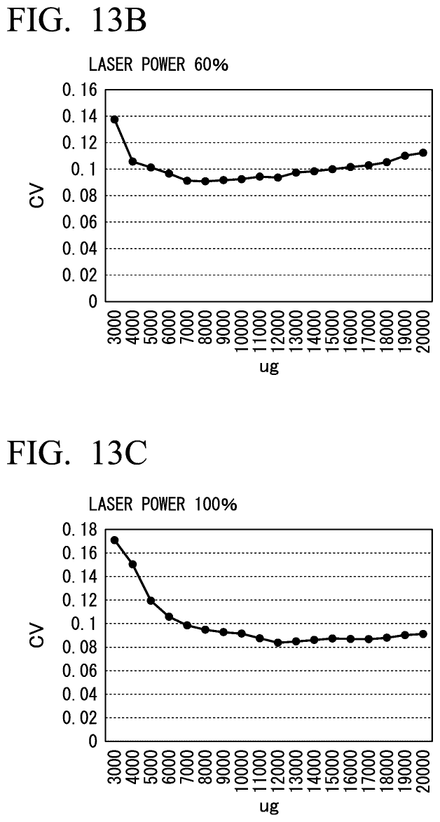

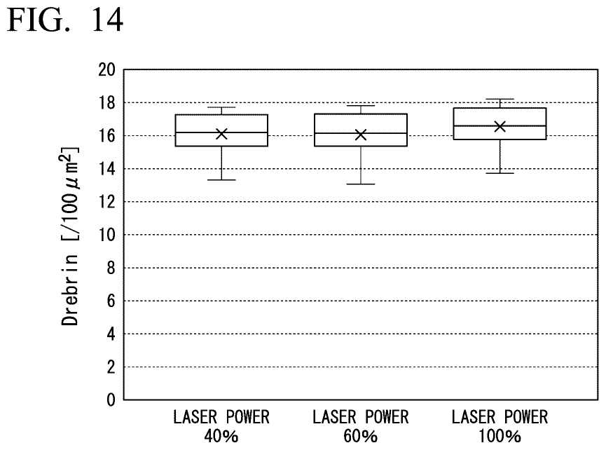

FIG. 1 is a diagram indicating an example of a configuration of a detection system 1 in a first embodiment. The detection system 1 is a system that detects images of minuscule detection targets from captured images. The detection system 1 extracts detection target image candidates from captured images by using an image processing algorithm that focuses on structures (shapes, colors) around the minuscule detection targets. The detection system 1 detects detection target images from among the extracted detection target image candidates by using, for example, a machine learning model or the like.

Captured images are, for example, images of biological samples captured at prescribed magnifications using an optical microscope. The captured images may be color images or monochrome (grey images). Color images may be RGB (red/green/blue) images or may be images in another color space (for example, Lab color space).

The detection targets are, for example, cell organelles, cytoskeletons, and proteins. The cell organelles are, for example, lysosomes, autophagosomes, cell tissues, vesicles, mitochondria, etc. The cytoskeletons are growth cones, dendritic spines of neurons, actin filaments, microtubules, etc. The proteins (protein aggregates) are, for example, synapsin that has accumulated at the synapses of neurons, synaptophysin, vesicular glutamate transporter (vGLUT), vesicular GABA transporter (vGAT), PSD-95 (postsynaptic density-95), drebrin, Homer, cell nuclei, micronuclei, stress granules, prions, β-amyloid, α-synuclein, etc.

The sizes of the minuscule detection targets are, for example, approximately from 0.01 μm to several μm³. As long as the sizes of the minuscule detection targets are minuscule (a predetermined threshold value or smaller) with respect to the captured images, and are not limited to a specific size.

The detection system 1 is provided with a communication line 2, an image transmission apparatus 3, and a detection apparatus 5. The communication line 2 may be a wired communication line or may be a wireless communication line. Additionally, the respective functional units in the respective apparatuses in the detection system 1 may be distributively arranged on a network, such as the internet, using cloud technology. Additionally, a single information processing apparatus may have the respective functional units of the respective apparatuses of the detection system 1.

The image transmission apparatus 3 is, for example, a server apparatus. The image transmission apparatus 3 pre-stores multiple captured images. The captured images include, for example, images of cells captured by an optical microscope. The image transmission apparatus 3 transmits the captured images to the detection apparatus 5 in response to a request from the detection apparatus 5.

During a detection stage (detection phase) in which a detection process is performed, the detection apparatus 5 uses a pre-constructed machine learning model to detect detection target images in captured images. The detection of the detection target images is not limited to being performed by a machine learning model, and may be performed by using other image processing algorithms. Hereinafter, an example of the case in which detection target images are detected by using a machine learning model will be explained. As the machine learning model, for example, a machine learning model generated by the fourth embodiment explained below can be used. The detection apparatus 5 has an operation unit 51, a communication unit 52, a storage apparatus 53, a memory 54, a detection execution unit 55, an enhancement unit 56, an assessment unit 57, a control unit 58, and a display unit 59.

The detection apparatus 5 is realized in the form of software by a processor such as a CPU (central processing unit) executing a program stored in the storage apparatus 53 having a non-volatile recording medium (non-transitory recording medium). The program may be recorded on a computer-readable recording medium. The detection apparatus 5 may be realized by using hardware including an electronic circuit or circuitry using, for example, an LSI (large-scale integrated circuit), an ASIC (application-specific integrated circuit), a PLD (programmable logic device), an FPGA (field-programmable gate array), etc.

The operation unit 51 is an operation device such as a mouse, a keyboard, a touch panel, etc. The operation unit 51 receives operations by a user. The operations by the user are, for example, operations for inputting, to the detection apparatus 5, instructions for selecting captured images in which detection target images are to be detected, changing the image enhancement parameters, selecting to display one enhanced image when there are multiple enhanced images obtained by enhancing captured images by means of the image enhancement parameters, and ending or not ending the execution of a detection process.

The communication unit 52 executes communication with the image transmission apparatus 3. The storage apparatus 53 pre-stores a computer program for the detection process using the machine learning model. The storage apparatus 53 may store the coordinates of respective detection target image candidates in enhanced images. A computer program for machine learning, such as deep learning, is loaded from the storage apparatus 53 into the memory 54. The memory 54 may comprise an auxiliary storage apparatus such as a graphics processing unit (GPU).

The detection execution unit 55 uses the machine learning model to detect detection target images in enhanced images obtained by the enhancement unit 56 enhancing captured images acquired from the image transmission apparatus 3. Such a machine learning model may use, as inputs, for example, image feature quantities obtained from pixel values of detection target image candidates. The detection execution unit 55 is provided with a preprocessing unit 551 and a detection unit 552.

The preprocessing unit 551 executes preprocessing on the processing target images. The processing target images are enhanced images obtained by the enhancement unit 56 performing image enhancement on the captured images. The preprocessing unit 551, by means of the preprocessing, generates detection target image candidates in the processing target images based on image feature quantities that are based on structures around the detection targets. The captured images include, for example, images of objects (for example, cells) having the detection targets (for example, drebrin), and noise images. The detection target image candidates are images of a prescribed shape and size cut out from the processing target images so as to include detection target candidate portions. The detection target candidate portions are at least one of granular (spherical, protruding) images distributed in the processing target images, and images of a prescribed shape and size including the granular images distributed in the processing target images. Additionally, the shapes of the detection target image candidates are, for example, rectangular. The detection target image candidates may be of any size as long as they are smaller than the sizes of the captured images (minuscule with respect to the processing target images) and are equal to or larger than the sizes of the detection target images. The preprocessing unit 551 may also serve as the enhancement unit 56.

The preprocessing unit 551 performs preprocessing for narrowing down the detection target image candidates based on the image feature quantities (for example, brightness) that are based on the structures around the detection targets. That is, the preprocessing unit 551 obtains one or both of extraction regions and exclusion regions in processing target images based on the image feature quantities that are based on the structures around the detection targets. The extraction regions are regions in which there is a high probability that an image of a structure around a detection target is included. The exclusion regions are regions in which there is a low probability that a structure around a detection target is included. The preprocessing unit 551 extracts, as detection target image candidates to be used in the detection process, candidates obtained from the extraction regions among the generated detection target image candidates. Additionally, the preprocessing unit 551 excludes, from among the detection target image candidates to be used in the detection process, candidates obtained from the exclusion regions among the generated detection target image candidates.

The preprocessing unit 551 may determine at least one of the extraction regions and the exclusion regions from the processing target images by executing a Hough transformation on the processing target images. Additionally, the preprocessing unit 551 may determine at least one of the extraction regions and the exclusion regions from the processing target images based on the curvature (shape index values) of protruding shapes in images distributed in the processing target images. The preprocessing unit 551 may determine at least one of the extraction regions and the exclusion regions from the processing target images based on at least one of a blob filter utilizing a Hessian matrix, histograms of oriented gradients utilizing first-order differences, and a difference-of-Gaussians filter utilizing a Gaussian function.

For example, in the case in which the detection targets are minuscule structures located around synapses, the preprocessing unit 551 may identify only images around dendritic protrusions as extraction regions, thereby extracting only images of the areas around the dendritic protrusions from among the generated detection target image candidates. In the case in which the fluorescent dye color of cell bodies including dendritic protrusions is different from the fluorescent dye color of synapses, the preprocessing unit 551 may execute peak detection in the protruding cell bodies by executing a distance conversion process on the processing target images. Additionally, the preprocessing unit 551 may identify coordinates near cell nuclei by fluorescent staining the cell nuclei. The preprocessing unit 551 may apply round masks to regions including peak positions based on distance information from peak positions. That is, the preprocessing unit 551 excludes candidates obtained from exclusion regions represented by the round masks among the generated detection target image candidates. In this way, the preprocessing unit 551 may use the round masks in the processing target images to remove the cell body images including cell nucleus images from the generated detection target image candidates.

The detection unit 552 uses the machine learning model to execute a detection process on the detection target image candidates obtained from the processing target images. For this purpose, the detection unit 552 inputs each detection target image candidate to the machine learning model. The inputs may be executed by a batch process. The detection unit 552 obtains outputs (probability distributions (probability maps), probability scores) from the machine learning model by inputting the detection target image candidates to the machine learning model. The detection unit 552 determines whether or not the detection target image candidates are detection target images based on the outputs from the machine learning model.

The detection execution unit 55 may derive, for the processing target images, statistical quantities regarding the sizes of detection target image candidates and statistical quantities regarding information on the surroundings of the detection target image candidates. The detection execution unit 55 may determine whether or not detection target image candidates are detection target images by using a support vector machine on the preprocessed processing target images based on the statistical quantities. The detection execution unit 55 may determine whether or not detection target image candidates are detection target images based on the results of a clustering method (for example, K-means) based on the statistical quantities.

The enhancement unit 56 generates enhanced images by performing image enhancement on captured images by means of designated image enhancement parameters. The image enhancement parameters are represented by sets of image enhancement types and one or more of types and values of image enhancement parameters used for the image enhancement. When the image enhancement types are predetermined, the image enhancement parameters may not include information on the image enhancement types. Additionally, the image enhancement parameters may include sets of two or more image enhancement types that are the same or different with one or more of types and values of enhancement parameters used for each type of image enhancement. Even if the image enhancement types or the enhancement parameter types are the same, the image enhancement parameters will be different if the enhancement parameter values are different. Examples of image enhancement types include, but are not limited to, image enhancement for changing pixel values such as color and brightness without changing the number of pixels, such as brightness level enhancement, contrast enhancement, gamma correction, black level enhancement, white level enhancement, etc.

For example, suppose that the image enhancement type is brightness level enhancement in which the brightness of 16-bit images captured with a microscope is clipped to within a brightness range of [lmin, lmax]. In brightness level enhancement, tone correction is performed linearly so that [lmin, lmax] corresponds to the values 0-255 in 8 bits. At this time, pixel values lower than lmin are set to 0 and pixel values higher than lmax are set to 255. In this case, the image enhancement types of the image enhancement parameters are set to brightness level enhancement, and the enhancement parameter types and values are set to lmin and the value thereof, and lmax and the value thereof.

The assessment unit 57 calculates assessment values regarding whether or not the detection accuracy is satisfactory, based on the number of images determined to be detection target images by the detection execution unit 55. The assessment values are statistical values of detection amounts obtained from enhanced images that have been enhanced by the same image enhancement parameters, as each of multiple captured images expected to have an equal number of detection target images. In the present embodiment, the statistical values of detection amounts are at least one of values representing variation in detection amounts and representative values of detection amounts. Additionally, the detection amounts obtained from the respective enhanced images represent at least one of the number of detection target images detected in the entire enhanced images and statistical values thereof, or at least one of the number of detection target images detected in regions in which many detection target images are expected to be detected in enhanced images and statistical values thereof.

The control unit 58 controls the respective units. The control unit 58 operates as an acquisition unit that acquires images from the image transmission apparatus 3. Additionally, the control unit 58 controls the detection execution unit 55, the enhancement unit 56, and the assessment unit 57, and calculates the assessment values in the case in which the captured images have undergone image enhancement, using each of the multiple different types of image enhancement parameters. The control unit 58 determines that the image enhancement parameters for which assessment values that are better than a prescribed value among the assessment values calculated for each of the different image enhancement parameters are to be employed for image enhancement by the enhancement unit 56. Assessment values that are better than a prescribed value can, for example, be assessment values that are within a prescribed ranking when the assessment values are ranked in the order of better values. The prescribed ranking may be first, i.e., the best assessment value. If the assessment value is a value representing the variation in detection amounts, smaller values are better assessment values, and if the assessment value is a representative value for detection amounts, larger values are better assessment values.

The display unit 59 is a display device such as a liquid crystal display. The display unit 59 displays enhanced images generated by the enhancement unit 56 using the image enhancement parameters determined by the control unit 58.

Generally, when culturing cells, equipment called a well plate (plate) is used. FIG. 2 is a diagram illustrating an example of a plate 6. There are multiple recesses (wells) 61 in the plate 6. There may be any number of wells 61. Cells can be cultured by changing conditions in each of the wells 61, such as by seeding the wells with different cell types or by adding different reagents to the same cell types. Cells are usually cultured under the same conditions in multiple wells 61 in one plate 6 in order to check for reproducibility. For example, cells in multiple wells 61 included in group A are cultured under the same conditions, and cells in multiple wells 61 included in group B are cultured under the same conditions that are different from those of group A.

Although at least one of a microscope and a fluorescence microscope is used when observing cultured cells, when capturing images of one well, it is divided into multiple fields of view and captured as separate images, due to constraints in the viewing angle and resolution. In the present embodiment, a single field of view will be referred to as a single image, images of multiple fields of view for a single well will be referred to as an image set, and multiple image sets for a single plate will be referred to as an image group. In the present embodiment, a single image corresponding to a single field of view corresponds to a single captured image. However, multiple images corresponding to multiple fields of view for the same well may be combined to form a single image. In this case, a single image and a single image set are substantially equivalent.

When culturing neurons by changing conditions of some sort, there are cases in which control cells are cultured in some of the wells in a single plate. Ideally, it is expected that the degree of maturity of the control cells becomes substantially about the same in the same plate, and the number of synapses per cell also becomes substantially equivalent. However, there is a case in which variation in the number of synapses that are detected for each well occurs, because the image quality is poor due to the image capture conditions and synapses were not appropriately captured. In the present embodiment, image enhancement parameters are selected under the assumption that those in which such variation is minimized or in which the number detected is maximized are optimal.

Next, the preprocessing and the detection process in the detection apparatus 5 will be explained.

FIG. 3 is a diagram illustrating an example of preprocessing of an enhanced image in the first embodiment. A processing target image 100 is an enhanced image obtained by the enhancement unit 56 having performed image enhancement on a captured image (original image) using image enhancement parameters. The captured image includes image of multiple cells stained by using one or more types of dyes or immunostaining methods. The shapes of respective cell bodies are similar to granular (spherical, protruding) shapes. The imaging magnification (angle of view) of the captured images is, for example, the imaging magnification in, for example, an optical microscope, and may be any magnification.

The preprocessing unit 551 executes a binarization process on the processing target image 100 (grey image). As a result thereof, the preprocessing unit 551 generates a processing target image 100a. The preprocessing unit 551 executes a blemish removal process on the processing target image 100a. As a result thereof, the preprocessing unit 551 generates a processing target image 100b.

The preprocessing unit 551 executes a distance conversion process and a peak detection process on the processing target image 100b. As a result thereof, the preprocessing unit 551 generates a processing target image 100c. Since the shapes of the respective cells are similar to granular (spherical, protruding), the positions of peaks detected by the peak detection process are positions near the centers (near the cell nuclei) of respective cell body images in the processing target image 100c. The preprocessing unit 551 generates a mask image 101 based on the positions of the detected peaks and the results of the distance conversion process. The mask image 101 includes round mask images centered near the centers of the respective cell body images. The sizes of the round mask images are defined in accordance with the results of the distance conversion process.

The preprocessing unit 551 executes a masking process using the mask image 101 on the processing target image 100c. As a result thereof, the preprocessing unit 551 generates a processing target image 100d. In the processing target image 100d, the images of the respective cell bodies are removed by the masking process and line-shaped images, such as dendritic protrusion images and axon images, which include synapse images remain. Drebrin, which is an example of a detection target, accumulates in the synapses of neurons. Therefore, for example, irregular images that are not near synapse images in a processing target image 100 have a high probability of being noise images. In this way, by the preprocessing unit 551 obtaining images (distributions) of synapses, which are structures around drebrin, in the processing target image 100d, drebrin images and noise images can be easily distinguished in the processing target image 100.

Next, the preprocessing and the detection process in the detection apparatus 5 will be explained.

FIG. 4 is a diagram illustrating an example of the preprocessing and the detection process on the enhanced image by the preprocessing unit 551 in the detection apparatus 5. The processing target image 200 is an enhanced image obtained by the enhancement unit 56 performing image enhancement on a captured image (original image). In FIG. 4, an enhanced image of a MAP2 (microtubule-associated protein 2) image portion in the original image is used as the processing target image 200. The processing target image 200 includes images of multiple cells stained by using one or more types of dyes or immunostaining methods. The shapes of the respective cell bodies are similar to granular (spherical, protruding) shapes. The imaging magnification (angle of view) of the original captured image from which the processing target image 200 was obtained is, for example, the imaging magnification in an optical microscope, and may be any magnification. The preprocessing unit 551 executes the above-described preprocessing on the processing target image 200. This preprocessing is similar to the preprocessing performed on captured images for training used in the training stage of the machine learning model used for the determination process. As a result thereof, the preprocessing unit 551 generates detection target image (drebrin image) candidates in the processing target image 200a. The preprocessing unit 551 associates coordinates in the processing target image 200a with detection target image candidates in the processing target image 200a.

In the processing target image 200a indicated in FIG. 4, multiple circular marks are drawn, for the sake of convenience, for the purpose of indicating the positions of detection target image (drebrin image) candidates in the synapses of neurons. The positions of the respective circular marks indicate the positions of the respective detection target image candidates. In the processing target image 200a, reference numbers are appended only for the detection target image 201 and the noise image 202 as representatives of detection target image candidates from the aspect of ensuring visibility of the drawing.

The detection target image candidate 210 is one of the detection target image candidates that are input to the machine learning model in the detection process. In this case, the machine learning model takes the detection target image candidate as an input, and outputs “drebrin class” (detection target class) or “noise class” (background class). The detection target image candidate 210 includes the detection target image 201 (granular image). The detection target image candidate 211 is one of the other candidates of the detection target image input to the machine learning model in the detection process. The detection target image candidate 211 includes a noise image 202 (irregular image). Thus, after the preprocessing has been executed by the preprocessing unit 551, during a stage in which a detection process using the machine learning model is not being executed by the detection unit 552, the detection target image candidates may include noise images 202.

The detection unit 552 uses the machine learning model to execute a detection process (inference process) on the processing target image 200a. In this case, the detection unit 552 inputs the respective detection target image candidates to the machine learning model. In FIG. 4, the detection unit 552 inputs the candidate 210 to the machine learning model and thereby obtains the output “drebrin class” from the machine learning model. As a result thereof, the detection unit 552 determines that the detection target image 201 in the candidate 210 is a detection target image (drebrin image). Additionally, the detection unit 552 inputs the candidate 211 to the machine learning model and thereby obtains the output “noise class” from the machine learning model. As a result thereof, the detection unit 552 determines that the noise image 202 in the candidate 211 is not a detection target image. That is, the detection unit 552 determines that the noise image 202 in the candidate 211 is a noise image.

FIG. 5 is a flow chart indicating an example of operations in the detection process in the detection system 1. The preprocessing unit 551 acquires an enhanced image from the enhancement unit 56 and identifies the enhanced image as a processing target image 200 (step S101). The preprocessing unit 551 extracts detection target image candidates 210, etc. from the processing target image 200 on the basis of structures around the detection targets (step S102). The preprocessing unit 551 records, in the storage apparatus 53, the coordinates of the respective detection target image candidates in the processing target image (step S103).

The detection unit 552 inputs the respective detection target image candidates to the machine learning model (step S104). The detection unit 552 selects, as respective detection target images, candidates 210, etc. that include detection target images 201 from among the respective detection target image candidates 210, etc. based on the output “drebrin class” from the machine learning model (step S105).

Next, the image enhancement parameter determination process by the detection system 1 will be explained. FIG. 6 is a diagram illustrating an example of operations in the image enhancement parameter determination process in the detection system 1.

The control unit 58 of the detection apparatus 5 acquires one or more captured images for determining image enhancement parameters from the image transmission apparatus 3 via the communication unit 52, and stores the captured images in the memory 54 (step S201). For example, the control unit 58 requests the image transmission apparatus 3 for captured images designated by a user operation on the operation unit 51. The communication unit 52 receives captured images returned from the image transmission apparatus 3 in response to the request and outputs the captured images to the control unit 58, and the control unit 58 stores the captured images that have been received in the memory 54. The captured images may also be stored in the storage apparatus 53. The captured images that are acquired may be single images, may be image sets, or may be image groups. Hereinafter, the explanation will proceed under the assumption that the captured images that are acquired are multiple image sets, i.e., image sets of multiple wells cultured under the same culture conditions in a single plate.

The control unit 58 selects one image enhancement parameter that has not yet been selected in a group of image enhancement parameters to be assessed (step S202). The group of image enhancement parameters to be assessed is, for example, pre-stored in the storage apparatus 53. The group of image enhancement parameters to be assessed may include image enhancement parameters for image enhancement of the same type, or may include image enhancement parameters for different types of image enhancement.

The control unit 58, by means of the enhancement unit 56, selects and reads out one of the captured images that have not yet been selected in an image set stored in the memory 54 (step S203). The enhancement unit 56 uses the image enhancement parameter selected in step S202 to generate an enhanced image by image enhancement of the captured image selected in step S203 (step S204). That is, the enhancement unit 56 performs, on the captured image, image enhancement of the type indicated by the image enhancement parameter, using an enhancement parameter of the type and value indicated by the image enhancement parameter. The enhancement unit 56 stores the enhanced image that has been generated in the memory 54 in association with the captured image and the image enhancement parameter that was used.

The control unit 58, by means of the detection execution unit 55, reads out the enhanced image generated in step S204 from the memory 54 and detects detection target images existing in the enhanced image that has been read out, and stores the detection target images in the memory 54 in association with the captured image (step S205). That is, the detection execution unit 55 performs the process in FIG. 5, using the enhanced image that has been read out as the processing target image 200. Although one or more detection target images will usually be detected from one enhanced image, the number of detected target images could be zero.

The control unit 58, by means of the assessment unit 57, reads out the detection target images that have been detected in step S205 from the memory 54 and calculates a detection amount (step S206). Examples of detection amounts include (a) detection count, (b) detection count per unit length, and (c) detection count per unit area. The (a) detection count is the number of detection target images detected in the enhanced image. The (b) detection count per unit length is used in the case in which detection target images are distributed along a line-shaped structure, and is calculated as the value of the number of detection target images divided by the length of the line-shaped structure. The (c) detection count per unit area is the value of the number of detection target images divided by the area of an effective region in a captured image. The control unit 58 stores the calculated detection amount in the memory 54 in association with the image enhancement parameter, the captured image, and the enhanced image.

The control unit 58 determines whether or not the process from step S203 to step S206 has been performed on all of the captured images acquired in step S201 (step S207). In the case in which it is determined that there is a captured image that is still unprocessed (step S207: NO), the control unit 58 repeats the process from step S203. In the case in which it is determined that the process from step S203 to step S206 has been performed on all of the captured images and the calculation of the detection amounts has been completed (step S207: YES), the control unit 58 advances to the process in step S208.

The control unit 58, by means of the assessment unit 57, reads out the detection amounts corresponding respectively to all of the captured images from the memory 54 and calculates an assessment value based on the detection amounts that have been read out (step S208). Examples of methods for computing the assessment values include (a) calculation of the variation, and (b) calculation of representative values. In the case of (a) calculation of the variation, at least one of the variance, standard deviation, and a coefficient of variation of the detection amounts obtained from the respective enhanced images of the multiple captured images is used as the assessment value. In the case of (b) calculation of representative values, at least one of the mean and median value of the detection amounts obtained from the respective enhanced images of the multiple captured images is used as the assessment value.

The control unit 58 may calculate the assessment value after first summing or averaging the detection amounts of the captured images belonging to a single image set. The control unit 58 stores the calculated assessment value in the memory 54 in association with the image enhancement parameter.

The control unit 58 reads out the assessment value from the memory 54 and compares the assessment value calculated in step S208 with the best (optimal value) among the assessment values that have already been compared (step S209). In the case in which it is determined that the calculated assessment value is better than the optimal value up to that point (step S209: YES), the control unit 58 updates the optimal value up to that point with the calculated assessment value, updates the optimal image enhancement parameter with the image enhancement parameter used in the enhanced images with which the assessment value of the updated optimal value was obtained, and stores the updated image enhancement parameter in the memory 54 (step S210). In the case of the initial determination in step S209, there is no previous optimal value for the assessment value, and therefore, the control unit 58 determines that the response in step S209 is YES and performs the process in step S210.

In the case in which it is determined that the optimal value up to that point is better than the calculated assessment value (step S209: NO), or after the process in step S210, the control unit 58 determines whether or not assessments have been completed for all of the image enhancement parameters in the image enhancement parameter group being assessed (step S211). In the case in which it is determined that there is an image enhancement parameter that has not yet been assessed (step S211: NO), the control unit 58 repeats the process from step S202. Meanwhile, in the case in which it is determined that the assessment has been completed for all of the image enhancement parameters (step S211: YES), the control unit 58 records, in the storage apparatus 53, the optimal image enhancement parameter that was stored in the memory 54 (step S212).

In addition to the above, the control unit 58 may also read out the enhanced image associated with the optimal image enhancement parameter from the memory 54 and may display the enhanced image on the display unit 59 together with the optimal image enhancement parameter. As a result thereof, the finally selected image enhancement parameter and the enhancement results thereof can be presented to the user.

For example, when performing an assay, a positive control will be generated in some of the wells in a plate. Therefore, in the plate 6 in FIG. 2, a positive control may be generated in the wells 61 in group A, and the actual analysis targets may be generated in other wells 61 including those in group B, etc. In this case, the optimal image enhancement parameter may be determined by using the captured image of a well 61 in group A as the captured image acquired in step S201, and the optimal image enhancement parameter that has been determined may be applied to the captured images of wells 61 other than those in group A, such as those in group B. However, this is one example, and the captured image acquired in step S201 is not limited to being that of a positive control.

In the present embodiment, based on the assumption that the detection amounts in the respective wells cultured under the same conditions will be the same, an image enhancement parameter for which the assessment value is the most stable, i.e., for which the variation is smallest, between the wells in a single plate, or an image enhancement parameter for which the overall detection amount is the largest, is selected. By using the image enhancement parameter selected in this manner to perform image enhancement on the captured image, stable detection results can be expected.

### Modified Example 1 of First Embodiment

In the first embodiment, the process ends when the image enhancement parameter is determined. In the present modified example, the determined image enhancement parameter is used to calculate the detection amount in a captured image to be used for analysis (hereinafter referred to as an analysis target captured image), which is the primary purpose. Modified Example 1 of the first embodiment will be explained by focusing on the differences from the first embodiment.

FIG. 7 a flow chart indicating an example of operations in an image enhancement parameter determination process in the detection system 1 in Modified Example 1 of the first embodiment. In FIG. 7, the processes that are the same as those in the flow chart according to the first embodiment indicated in FIG. 6 will be assigned the same reference numbers, and the explanations thereof will be omitted.

The detection apparatus 5 performs the processes in step S201 to step S212 indicated in FIG. 6. The control unit 58 of the detection apparatus 5 acquires one or more analysis target captured images from the image transmission apparatus 3 via the communication unit 52, and stores the analysis target captured images in the memory 54 (step S221). For example, the control unit 58 requests the image transmission apparatus 3 for analysis target captured images designated by a user operation on the operation unit 51. The communication unit 52 receives analysis target captured images returned from the image transmission apparatus 3 in response to the request and outputs the analysis target captured images to the control unit 58, and the control unit 58 stores the analysis target captured images that have been received in the memory 54. The present steps may be collectively implemented in step S201.

The control unit 58, by means of the enhancement unit 56, reads out the analysis target captured images stored in the memory 54, and also reads out, from the storage apparatus 53, the optimal image enhancement parameter recorded in step S212. The enhancement unit 56 generates analysis target enhanced images by image enhancement of each of the analysis target captured images that have been read out by means of the optimal image enhancement parameter that has been read out (step S222). The control unit 58 stores the analysis target enhanced images that have been generated in the memory 54 in association with the captured images before the enhancement.

The control unit 58, by means of the detection execution unit 55, selects and reads out one of the analysis target enhanced images, which have not yet been selected, from the memory 54 (step S223). The detection execution unit 55 detects detection target images in the analysis target enhanced image that has been read out and stores the detection target images in the memory 54 (step S224). That is, the detection execution unit 55 performs the process in FIG. 5, using the analysis target enhanced image that has been read out as a processing target image 200. The control unit 58, by means of the assessment unit 57, reads out the detection target images stored in step S224 from the memory 54 and calculates a detection amount in the same manner as in step S206 (step S225).

The control unit 58 repeats the process from step S223 to step S225 with respect to all of the analysis target enhanced images generated in step S222. That is, the control unit 58 determines whether or not the process from step S223 to step S225 has been performed on all of the analysis target enhanced images (step S226). In the case in which it is determined that there is an analysis target enhanced image that is still unprocessed (step S226: NO), the control unit 58 repeats the process from step S223. In the case in which it is determined that the process from step S223 to step S225 has been performed on all of the analysis target enhanced images (step S226: YES), the control unit 58 advances to the process in step S227.

The control unit 58, by means of the assessment unit 57, reads out the detection amounts obtained for the respective analysis target enhanced images for all of the captured images and calculates an assessment value based on the detection amounts that have been read out (step S227).

In addition to the above, the control unit 58 may read out at least one of the analysis target enhanced images and the analysis target captured images from the storage apparatus 53 and may present them to the user by displaying them on the display unit 59 together with the assessment values.

For example, the captured images acquired in step S201 can be captured images of a well 61 in group A in the plate 6 illustrated in FIG. 2, and the analysis target captured images acquired in step S221 may be captured images of wells 61 in groups with different culture conditions from those in group A, such as those in group B. In this case, group A may be, but is not limited to being, a positive control.

### Modified Example 2 of First Embodiment

In the first embodiment, the process ends when the image enhancement parameter is determined by the detection system 1. In the present modified example, the detection system 1 presents the determined image enhancement parameter to the user, and the user corrects the image enhancement parameter that is presented depending on a need. Modified Example 2 of the first embodiment will be explained by focusing on the differences from the first embodiment.

FIG. 8 is a flow chart indicating an example of operations in an image enhancement parameter determination process in detection system 1 in Modified Example 2 of the first embodiment. In FIG. 8, the processes that are the same as those in the flow chart according to the first embodiment indicated in FIG. 6 will be assigned the same reference numbers, and the explanations thereof will be omitted.

The detection system 1 performs processes similar to those in step S201 to step S211 indicated in FIG. 6. When it is determined that the assessment has been completed for all of the image enhancement parameters in step S211 (step S211: YES), the control unit 58 instructs the enhancement unit 56 to perform the process in step S231. As a result thereof, the enhancement unit 56 reads out a captured image on which image enhancement is to be performed, from the memory 54. Furthermore, the enhancement unit 56 reads out the optimal image enhancement parameter that has been determined by the process up to step S211, from the memory 54. The enhancement unit 56 uses the optimal image enhancement parameter that has been read out to perform image enhancement on the captured image that has been read out to generate an enhanced image (step S231). The control unit 58 stores the enhanced image generated by the enhancement unit 56 in the memory 54.

The control unit 58 reads out the enhanced image generated in step S231 from the memory 54 and displays the enhanced image on the display unit 59 together with the optimal image enhancement parameter (step S232). The control unit 58 enters a state in which instructions for correcting the optimal image enhancement parameter by means of the operation unit 51 can be received. The user operates the operation unit 51 to input an instruction to correct the optimal image enhancement parameter as needed.

In the case in which it has been determined that an instruction to correct the image enhancement parameter has been input (step S233: YES), the control unit 58 updates the optimal image enhancement parameter stored in the memory 54 with the corrected image enhancement parameter input by the user (step S234). The control unit 58 stores the updated optimal image enhancement parameter in the storage apparatus 53 (step S212). Meanwhile, in the case in which it has been determined that an instruction to correct the image enhancement parameter has not been received (step S233: NO), the control unit 58 records the optimal image enhancement parameter that was stored in the memory 54 in step S210, unchanged, in the storage apparatus 53 (step S212).

In addition to the above, the control unit 58 may repeat the process from step S231 to step S212. Additionally, the detection system 1 may perform the process from step S221 and later in FIG. 7 after the process in step S212.

Due to the present modified example, in the case in which the image enhancement parameter selected by the detection apparatus 5 is not in agreement with the user's intentions, the image enhancement parameter can be corrected by instructions from the user, thereby allowing a fail-safe function to be realized.

### Second Embodiment

In the second embodiment, the assessment regarding whether or not the image enhancement parameter is satisfactory in the first embodiment is performed based on the “difference from an assessment value of a plate used as a reference”. The second embodiment will be explained by focusing on the differences from the first embodiment.

The apparatus configuration diagram and processing flow diagram for the second embodiment are similar to those of the first embodiment. However, the control unit 58 determines to use an image enhancement parameter for which, among the respective assessment values of the different image enhancement parameters, the assessment value is closer than a prescribed distance to a reference value. The reference value is a prescribed assessment value that serves as a reference. The assessment value that is closer than a prescribed distance to the reference value may be an assessment value that is within a prescribed ranking when the assessment values are ranked by closeness to the reference value, or may be an assessment value for which the difference from the reference value is within a prescribed value. For example, the prescribed ranking may be first, i.e., the assessment value may be the closest to the reference value.

Next, the operations of the detection system 1 according to the second embodiment will be explained. Hereinafter, the explanation will focus only on the portions different from the flow chart indicated in FIG. 6. The different portions below may be applied to the flow chart in FIG. 7 or FIG. 8.

The detection system 1 performs the process from step S201 to step S207 indicated in FIG. 6. In step S208, the control unit 58, by means of the assessment unit 57, reads out the detection amounts corresponding to all of the captured images from the memory 54, calculates a representative value based on the detection amounts that have been read out, and calculates an assessment value based on the calculated representative value. Examples of the representative value include a mean value and a median value. As the assessment value, the difference between the representative value and a pre-designated reference value may be employed. The control unit 58 stores the calculated assessment value in the memory 54.

As the reference value, an initial value of the system recorded in the storage apparatus 53 may be used, or the value may be designated by the user by means of the operation unit 51. Additionally, the control unit 58 may acquire a captured image of a plate that is to serve as a reference from the image transmission apparatus 3 via the communication line 2 by means of the communication unit 52, and may use an assessment value calculated by performing the process from step S202 to step S208 as the reference value.

In step S209, the control unit 58 reads out the assessment value calculated in step S208 from the memory 54 and compares the assessment value with the best value (optimal value) among the assessment values that have already been compared. In the case in which it is determined that the assessment value is better than the optimal value up to that point (step S209: YES), the control unit 58, in step S210, updates the optimal value up to that point with the calculated assessment value, updates the optimal image enhancement parameter with the image enhancement parameter used in the enhanced image with which the updated optimal value was obtained, and stores the updated image enhancement parameter in the memory 54. In the case in which the difference between the reference value and a representative value is employed as the assessment value, the result can be considered to be better when the absolute value of the difference is smaller. Therefore, the image enhancement parameter for which the absolute value of the difference is the smallest is employed as the optimal image enhancement parameter.

The process from step S211 to step S212 in the detection system 1 is the same as that in FIG. 6.

The assessment values of respective wells cultured under the same conditions can be assumed to be the same even between plates. Therefore, the detection apparatus 5 selects an image enhancement parameter for which the representative values are close between plates and for which similar assessment values are obtained. By performing image enhancement of captured images using an image enhancement parameter selected in this way, stable detection results can be expected. For example, by determining a reference value from a plate that is to serve as a reference and performing image enhancement of captured images of different plates so as to be close to that reference value, image quality close to that of the plate serving as the reference can be expected to be obtained.

### Third Embodiment

In the third embodiment, when assessing the image enhancement parameter used for image enhancement, the assessment value from the first embodiment and the assessment value from the second embodiment are combined. The third embodiment will be explained by focusing on the differences from the first embodiment.

The apparatus configuration diagram and processing flow diagram for the third embodiment are similar to those of the first embodiment. However, the assessment unit 57 calculates, for each different image enhancement parameter, a first assessment value (assessment value of a variation amount) that is an assessment value calculated in a manner similar to that in the first embodiment, and a second assessment value (assessment value of a representative value) that is an assessment value calculated in a manner similar to that in the second embodiment. The assessment unit 57 calculates an overall assessment value based on the first assessment value and the second assessment value. The control unit 58 selects, as the optimal image enhancement parameter, an image enhancement parameter for which the overall assessment value is better than a prescribed value.

Next, the operations of the detection system 1 according to the third embodiment will be explained. Hereinafter, the explanation will focus only on the portions different from the flow chart indicated in FIG. 6. The different portions below may be applied to the flow chart in FIG. 7 or FIG. 8.

The detection system 1 performs the process from step S201 to step S207 indicated in FIG. 6. In step S208, the control unit 58, by means of the assessment unit 57, reads out the detection amounts corresponding to all of the captured images from the memory 54, and calculates a variation amount and a representative value based on the detection amounts that have been read out. Next, the assessment unit 57 calculates a first assessment value that is an assessment value of the variation amount based on the variation amount calculated for the captured images, and calculates a second assessment value that is an assessment value of the representative value based on the representative value calculated for the captured images. Finally, the assessment unit 57 calculates an overall assessment value by combining the first assessment value with the second assessment value.

As the variation amount, at least one of the variance, standard deviation, and a coefficient of variation in the detection amounts obtained from the respective enhanced images of the multiple captured images may be used, as indicated in the first embodiment. Examples of the first assessment value include (a1) the variation amount itself, (a2) a ratio with respect to a reference value, (a3) a value normalized by using a maximum value and a minimum value that are expected, etc. The ratio with respect to a reference value in (a2) is the calculated variation amount divided by a preset variation amount reference value. The value normalized by using a maximum value and a minimum value that are expected in (a3) is obtained by subtracting the expected minimum value from the calculated variation amount and dividing the result by the difference between the expected maximum value and the expected minimum value.

As the representative value, at least one of the mean and median value of the detection amounts obtained from the respective enhanced images of the multiple captured images may be used, as indicated in the second embodiment. Examples of the second assessment value include (b1) the representative value itself, (b2) the difference from a reference value, (b3) a value normalized by using a maximum value and a minimum value that are expected, etc. The difference from a reference value in (b2) is the difference between the calculated representative value and a preset reference value for the representative value (indicated as an assessment value in the second embodiment). The value normalized by using a maximum value and a minimum value that are expected in (b3) is obtained by subtracting the expected minimum value from the calculated representative value and dividing the result by the difference between the expected maximum value and the expected minimum value.

Examples of the method for combining the first assessment value and the second assessment value include taking (c1) the better value between the two, (c2) a weighted average, and (c3) a value normalized by using a maximum value and a minimum value that are expected. The (c1) better value between the two involves using the better value between the first assessment value and the second assessment value as the overall assessment value. The (c2) weighted average is averaged by weighting each of the first assessment value and the second assessment value. As the weighting, a preset weighting may be used, or it may be designated by the user. The (c3) value normalized by using a maximum value and a minimum value that are expected is the sum of the normalized first assessment value and the normalized second assessment value. The normalized first assessment value is obtained by subtracting the expected minimum value of the first assessment value from the first assessment value and dividing the result by the difference between the expected maximum value of the first assessment value and the expected minimum value of the first assessment value. The normalized second assessment value is obtained by subtracting the expected minimum value of the second assessment value from the second assessment value and dividing the result by the difference between the expected maximum value of the second assessment value and the expected minimum value of the second assessment value.

In the case in which the relationship between magnitude and what is good or bad differs between the first assessment value and the second assessment value (for example, if the former value is better when larger and the latter value is better when smaller, etc.), it is preferable to combine the two after making corrections to align the relationship between magnitude and what is good or bad.

In step S209, the control unit 58 reads out the overall assessment value calculated in step S209 from the memory 54 and compares the overall assessment value with the best value (optimal value) among the overall assessment values that have already been compared. In the case in which it is determined that the overall assessment value is better than the optimal value up to that point (step S209: YES), the control unit 58, in step S210, updates the optimal value up to that point with the calculated overall assessment value, updates the optimal image enhancement parameter with the image enhancement parameter used in the enhanced images with which the overall assessment value of the updated optimal value was obtained, and stores the updated image enhancement parameter in the memory 54.

The process from step S211 to step S212 in the detection system 1 is the same as the process indicated by the flow chart in FIG. 6.

### Fourth Embodiment

The present embodiment is provided with a training apparatus that trains the machine learning model used for the detection process by the detection apparatus 5 in the first to third embodiments. Although the fourth embodiment will be explained by focusing on the differences from the first embodiment, the differences between the fourth embodiment and the first embodiment may be applied to the detection systems of Modified Examples 1 and 2 of the first embodiment, the second embodiment, and the third embodiment.

FIG. 9 is a diagram illustrating an example of the configuration of the detection system 1a in the fourth embodiment. In the diagram, the portions that are the same as those in the detection system 1 according to the first embodiment indicated in FIG. 1 will be assigned the same reference numbers, and the explanations thereof will be omitted. The detection system 1a illustrated in FIG. 9 differs from the detection system 1 illustrated in FIG. 1 in that a training apparatus 4 is further provided. The training apparatus 4 and the detection apparatus 5 may be integrated or separate.

The training apparatus 4 executes training of the machine learning model used by the detection unit 552 based on training images. The machine learning model includes, for example, a neural network such as a convolutional neural network (CNN). The training apparatus 4 is provided with an operation unit 41, a communication unit 42, a storage unit 43, a memory 44, a training execution unit 45, and a display unit 46.

The training apparatus 4 is realized in the form of software by a processor such as a CPU executing a program stored in the memory 44 and the storage apparatus 43 having a non-volatile recording medium (non-transitory recording medium). The program may be recorded on a computer-readable recording medium. The computer-readable recording medium is, for example, a portable medium such as a flexible disk, a magneto-optic disk, a ROM, or a CD-ROM, or a non-transitory recording medium, for example, a storage apparatus such as a hard disk or a solid state drive (SSD) inside a computer system. The training apparatus 4 may also be realized by using hardware including an electronic circuit using, for example, an LSI, an ASIC, a PLD, or an FPGA.

The operation unit 41 is an operation device such as a mouse, a keyboard, and a touch panel. The operation unit 41 receives operations by the user. The communication unit 42 executes communication with the image transmission apparatus 3. Additionally, the communication unit 42 executes communication with the communication unit 52. The storage apparatus 43 pre-stores teacher data and a computer program for a training process using the machine learning model. The teacher data is a combination of a training image (explanatory variable) and a correct label (objective variable). A computer program for machine learning, such as deep learning, is loaded from the storage apparatus 43 into the memory 44. The memory 44 may be provided with an auxiliary storage apparatus such as a graphics processing unit (GPU).

The training execution unit 45 uses the training images and the correct labels to execute training of the machine learning model. The training execution unit 45 adjusts the parameters of the machine learning model by using, for example, error backpropagation with respect to outputs (probability distributions (probability maps), probability scores) from the machine learning model. In this case, one type of detection target is associated with each probability distribution. In the case in which multiple machine learning models are used, the probability distributions of the respective detection targets may be combined (added).

The training execution unit 45 is provided with a preprocessing unit 451 and a training unit 452. The preprocessing unit 451 uses captured images acquired from the image transmission apparatus 3 as processing target images to execute preprocessing like that of the preprocessing unit 551. The preprocessing unit 451 extracts training images containing detection target images from captured images containing noise images and images of objects (for example, cells) having detection targets (for example, drebrin), on the basis of image feature quantities (for example, brightness) based on structures around the detection targets. The preprocessing unit 451 generates teacher data by adding correct labels to detection target image candidates of the respective training images based on operations by a user.

The training unit 452 executes training of the machine learning model based on the training images. The training unit 452 inputs the respective training images to the machine learning model. The training unit 452 adjusts the parameters of the machine learning model so as to reduce the error between the correct labels and the outputs (classes) from the machine learning model for each training image.

Next, the training process in the training apparatus 4 will be explained. FIG. 10 is a diagram illustrating an example of a captured image 300 for use in training in the fourth embodiment. Each training images in the teacher data are partial images (each sub-region, each sub-image) defined in the captured images 300 for use in training. The shapes and sizes of the training images are the same shapes and sizes as the detection target image candidates cut out from the processing target images by the preprocessing unit 551 in the detection apparatus 5. A training image 310 includes a detection target image 311 (drebrin image) in a synapse of a neuron. The training image 320 includes a detection target image 321 (drebrin image) in a synapse of a neuron. The training image 330 includes a noise image 331 at a position not in a synapse of a neuron.

In the captured image 300 illustrated in FIG. 10, reference numbers are assigned only to the training image 310, the training image 320, and the training image 330 as representatives of training images from the aspect of ensuring visibility of the drawing. Even more training images may be defined in the captured image 300.

The user operates the operation unit 41 while viewing the captured image 300 for use in training displayed on the display unit 46. The user defines a correct label for each training image by operating the operation unit 41. In this case, drebrin, which is an example of a detection target, accumulates in the synapses of neurons. Therefore, for example, granular images located near dendritic protrusion images and axon images, including synapse images, have a high probability of being drebrin images.

For example, since the training image 310 includes a synapse image, the user associates the correct label “drebrin class” (detection target class) with the training image 310. Additionally, since the training image 320 includes a synapse image, the user associates the correct label “drebrin class” with the training image 320. Additionally, for example, the training image 330 does not contain a synapse image and the noise image 131 is an irregular image (non-granular image). Additionally, the contrast components at the outline of the noise image 131 are not high. For these reasons, the user associates the correct label “noise class” or “background class” with the training image 320.

FIG. 11 is a flow chart illustrating an example of operations in the training apparatus 4 in the fourth embodiment. The training execution unit 45 in the training apparatus 4 acquires a captured image 300 for use in training from the image transmission apparatus 3 (step S301). The preprocessing unit 451 extracts the training image 310, the training image 320, etc. from the captured image 300 for use in training based on being within a prescribed distance from a structure (synapse) around a detection target (drebrin). The preprocessing unit 451 may extract the training image 330, etc. from the captured image 300 for use in training based on being a prescribed distance or more away from a structure around a detection target (step S302). The preprocessing unit 451 associates each of the training images 310, 320, 330 extracted in step S302 with a correct label based on operations received by the operation unit 41 (step S303).

The training unit 452 inputs each of training images to the machine learning model (step S304). The training unit 452 adjusts the parameters in the machine learning model so as to reduce the error between the correct labels and the outputs (classes) from the machine learning model for each training image (step S305). The training unit 452 determines whether or not the training process has ended based, for example, on operations received by the operation unit 41 (step S306). In the case in which the training process is to be continued (step S306: NO), the training unit 452 returns the process to step S301. In the case in which the training process is to be ended (step S306: YES), the training unit 452 records the machine learning model in the storage apparatus 43 (step S307).

The control unit 58 of the detection apparatus 5 acquires the machine learning model (trained model) that has been trained as described above from the training apparatus 4.

### Experiments Relating to Image Enhancement Parameter

An example illustrating that appropriate image enhancement parameters will differ depending on the image capture conditions will be explained below. Fluorescence imaging was performed on cells of the same sample by changing the laser power at the time of image capture to 40, 60, and 100%. By using different laser power on the same subject, captured images having different brightness distributions were intentionally generated. In actual practice, it is common to capture images using 100% or close to 100% laser power, without changing the laser power of respective imaging devices. However, there are cases in which unexpected brightness changes occur even when the same device is used, or the laser power differs depending on the imaging device, and the laser power was changed in order to simulate such situations.

FIG. 12 is a diagram indicating detection amounts in enhanced images obtained by image enhancement using the same image enhancement parameter on captured images captured by changing the laser power. In this case, the detection amounts were counted in each of the wells, and the distribution for nine wells at each laser power is indicated by a box-and-whisker plot. As indicated in FIG. 12, when the same image enhancement parameter was used on captured images with different laser power, the detection results largely changed.

In contrast therewith, enhanced images were generated by performing image enhancement while changing the enhancement parameter value of the image enhancement parameter for each captured image with a different laser power, a detection process was performed on each of the enhanced images to determine a detection amount, and an assessment value of the image enhancement parameter was calculated based on the determined detection amounts. As the assessment value, the coefficient of variation (CV) of the detection amounts was used. FIG. 13A to FIG. 13C are diagrams indicating assessment values for each enhancement parameter value. FIG. 13A indicates assessment values for respective image enhancement parameters obtained for captured images at 40% laser power. FIG. 13B indicates assessment values for respective image enhancement parameters obtained for captured images at 60% laser power. FIG. 13C indicates assessment values for respective image enhancement parameters obtained for captured images at 100% laser power. As indicated in FIG. 13A to FIG. 13C, the image enhancement parameters (enhancement parameter values) for which the assessment values are good differ depending on the image capture conditions.

FIG. 14 is a diagram indicating detection amounts in enhanced images obtained by image enhancement using image enhancement parameters with enhancement parameter values minimizing the assessment value for each captured image captured by changing the laser power. FIG. 14 indicates a box-and-whisker plot of detection values obtained from enhanced images of captured images at 40% laser power, a box-and-whisker plot of detection values obtained from enhanced images of captured images at 60% laser power, and a box-and-whisker plot of detection values obtained from enhanced images of captured images at 100% laser power. From FIG. 14, it can be understood that approximately the same detection value is obtained at each laser power.

In the above, an example of the case, in which the brightness of captured images differs due to image capture conditions differing when performing fluorescent imaging of cells, was indicated. However, the brightness of captured images will also differ in the case in which the image capture device and the states of cells differ. Therefore, the optimal image enhancement parameters can also be expected to differ. In the embodiments mentioned above, image enhancement parameters for image enhancement that will stabilize the detection performance of images of minuscule detection targets can be automatically determined, even in captured images with different image quality due to the image capture device or the state of cells being different. More specifically, regions of captured images, in which detection results of images of detection targets can be expected to be substantially the same regardless the image quality, are designated, and image enhancement parameters are determined so that the detection results for those regions satisfy conditions expected in images of high image quality.

Additionally, according to the embodiments mentioned above, image enhancement parameters are determined by using assessment values obtained by statistical processing of detection amounts determined from multiple captured images. Therefore, the image enhancement parameters can be determined, for example, by suppressing the variation occurring in each well in a single plate or by using the variation itself. Additionally, in the embodiments mentioned above, the preprocessing unit 551 having an algorithm with less computation than the detection unit 552 is used to extract detection target image candidates, and detection target images are detected from among the candidates extracted by the detection unit 552. Therefore, the computational efficiency of the detection apparatus 5 overall can be improved.

According to at least one exemplary embodiment, for example, the detection performance of images of minuscule detection targets can be stabilized even in captured images in which the image quality differs.

The present disclosure includes the embodiments below.
[1] A detection apparatus provided with an acquisition unit configured to acquire at least one captured image obtained by capturing a subject including an object having a detection target; an enhancement unit configured to generate an enhanced image obtained by image enhancement of the at least one captured image using an image enhancement parameter; a detection unit configured to detect an image of the detection target from the enhanced image; an assessment unit configured to calculate an assessment value for detection accuracy based on a detection result by the detection unit; and a control unit configured to determine, among a plurality of image enhancement parameters, an image enhancement parameter to be used by the enhancement unit for image enhancement of at least one captured image to be analyzed, based on the assessment value calculated for each of a plurality of different image enhancement parameters.
[2] The detection apparatus according to [1], wherein the acquisition unit is configured to acquire a plurality of captured images; and the assessment unit is configured to calculate the assessment value of the image enhancement parameter by performing a statistical process on detection results obtained by the detection unit for each of a plurality of enhanced images that are generated by using a same image enhancement parameter for the plurality of captured images.
[3] The detection apparatus according to [2], wherein the statistical process is a process for calculating variation in the detection results; and the control unit is configured to determine that an image enhancement parameter for which an assessment value with minimum variation is obtained is to be used for image enhancement of the at least one captured image to be analyzed.
[4] The detection apparatus according to [2], wherein the statistical process is a process for calculating a representative value of the detection result; and the control unit is configured to determine that an image enhancement parameter for which assessment value closest to a prescribed value was obtained is to be used for image enhancement of the at least one captured image to be analyzed.
[5] The detection apparatus according to [1], wherein the acquisition unit is configured to acquire a plurality of captured images; the assessment unit is configured to calculate as the assessment value of the image enhancement parameter, using detection results obtained by the detection unit for each of a plurality of enhanced images that are generated by using a same image enhancement parameter for the plurality of captured images, a first assessment value indicating variation in the detection results and a second assessment value indicating a representative value of the detection results; and the control unit is configured to determine the image enhancement parameter, among the plurality of image enhancement parameters, to be used by the enhancement unit for image enhancement of the at least one captured image to be analyzed, based on the first assessment value and the second assessment value calculated for each of the plurality of image enhancement parameters that are different from each other.
[6] The detection apparatus according to any one of [1] to [5], further comprising a preprocessing unit configured to extract detection target image candidates including the detection target from the enhanced image; wherein the detection unit is configured to detect the image of the detection target from among the detection target image candidates extracted by the preprocessing unit.
[7] The detection apparatus according to any one of [1] to [5], wherein the control unit is configured to display, on a display apparatus, the enhanced image enhanced by the image enhancement parameter that has been determined, and correct the determined image enhancement parameter based on a user input by an operation unit.
[8] A method for determining image enhancement parameter, the method including acquiring at least one captured image obtained by capturing a subject including an object having a detection target; generating an enhanced image obtained by image enhancement of the at least one captured image using an image enhancement parameter; detecting an image of the detection target from the enhanced image; calculating an assessment value for detection accuracy based on a detection result obtained in the detecting; and determining, among a plurality of image enhancement parameters, an image enhancement parameter to be used in the generating for image enhancement of at least one captured image to be analyzed, based on the assessment value calculated for each of a plurality of different image enhancement parameters.
[9] A program for causing a computer to function as the detection apparatus according to [1].

While embodiments of the present disclosure have been explained in detail with reference to the drawings, the specific configurations are not limited to these embodiments, and designs, etc. within a range not departing from the spirit of this disclosure are included.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A detection apparatus comprising:
acquisition circuitry configured to acquire at least one captured image obtained by capturing a subject including an object having a detection target;
enhancement circuitry configured to generate an enhanced image obtained by image enhancement of the at least one captured image using an image enhancement parameter;
detection circuitry configured to detect an image of the detection target from the enhanced image;
assessment circuitry configured to calculate an assessment value for detection accuracy based on a detection result by the detection circuitry; and
control circuitry configured to determine, among a plurality of image enhancement parameters, an image enhancement parameter to be used by the enhancement circuitry for image enhancement of at least one captured image to be analyzed, based on the assessment value calculated for each of a plurality of different image enhancement parameters.

2. The detection apparatus according to claim 1, wherein:
the acquisition circuitry is configured to acquire a plurality of captured images; and
the assessment circuitry is configured to calculate the assessment value of the image enhancement parameter by performing a statistical process on detection results obtained by the detection circuitry for each of a plurality of enhanced images that are generated by using a same image enhancement parameter for the plurality of captured images.

3. The detection apparatus according to claim 2, wherein:
the statistical process is a process for calculating variation in the detection results; and
the control circuitry is configured to determine that an image enhancement parameter for which an assessment value with minimum variation is obtained is to be used for image enhancement of the at least one captured image to be analyzed.

4. The detection apparatus according to claim 2, wherein:
the statistical process is a process for calculating a representative value of the detection result; and
the control circuitry is configured to determine that an image enhancement parameter for which assessment value closest to a prescribed value was obtained is to be used for image enhancement of the at least one captured image to be analyzed.

5. The detection apparatus according to claim 1, wherein:
the acquisition circuitry is configured to acquire a plurality of captured images;
the assessment circuitry is configured to calculate as the assessment value of the image enhancement parameter, using detection results obtained by the detection circuitry for each of a plurality of enhanced images that are generated by using a same image enhancement parameter for the plurality of captured images, a first assessment value indicating variation in the detection results and a second assessment value indicating a representative value of the detection results; and
the control circuitry is configured to determine the image enhancement parameter, among the plurality of image enhancement parameters, to be used by the enhancement circuitry for image enhancement of the at least one captured image to be analyzed, based on the first assessment value and the second assessment value calculated for each of the plurality of image enhancement parameters that are different from each other.

6. The detection apparatus according to claim 1, further comprising:
preprocessing circuitry configured to extract detection target image candidates including the detection target from the enhanced image,
wherein the detection circuitry is configured to detect the image of the detection target from among the detection target image candidates extracted by the preprocessing circuitry.

7. The detection apparatus according to claim 1, wherein:
the control circuitry is configured to display, on a display apparatus, the enhanced image enhanced by the image enhancement parameter that has been determined, and correct the determined image enhancement parameter based on a user input by operation circuitry.

8. A method for determining an image enhancement parameter, the method comprising:
acquiring at least one captured image obtained by capturing a subject including an object having a detection target;
generating an enhanced image obtained by image enhancement of the at least one captured image using the image enhancement parameter;
detecting an image of the detection target from the enhanced image;
calculating an assessment value for detection accuracy based on a detection result obtained in the detecting; and
determining, among a plurality of image enhancement parameters, an image enhancement parameter to be used in the generating for image enhancement of at least one captured image to be analyzed, based on the assessment value calculated for each of a plurality of different image enhancement parameters.

9. A non-transitory recording medium for recording a program that causes a computer to execute processes as the detection apparatus, the processes comprising:
acquiring at least one captured image obtained by capturing a subject including an object having a detection target;
generating an enhanced image obtained by image enhancement of the at least one captured image using an image enhancement parameter;
detecting an image of the detection target from the enhanced image;
calculating an assessment value for detection accuracy based on a detection result obtained in the detecting; and
determining, among a plurality of image enhancement parameters, an image enhancement parameter to be used in the generating for image enhancement of at least one captured image to be analyzed, based on the assessment value calculated for each of a plurality of different image enhancement parameters.
